(19) United States
(12) Patent Application Publication
(10) Pub. No.: US 2003/0114612 A1
(43) Pub. Date: Jun. 19, 2003

(54) Coupled diene polymers modified with electrophilic groups

(76) Inventors: Michael Grun, Siegburg (DE); Thomas Knauf, Dormagen (DE); Wilfried Braubach, Solingen (DE)

Correspondence Address: BAYER CORPORATION, PATENT DEPARTMENT, 100 BAYER ROAD, PITTSBURGH, PA, 15205, US

(21) Appl. No.: 10/211,118

(22) Filed: Aug. 2, 2002

(30) Foreign Application Priority Data
Aug. 6, 2001 (DE) 10139304.0
Apr. 22, 2002 (DE) 10217800.3

(51) Int. Cl. C08F 2/00

(52) U.S. Cl. 526/204

(57) ABSTRACT

The coupled polymers according to the present invention based on conjugated dienes or on conjugated dienes and vinylaromatic compounds and that are modified with electrophilic groups, prepared by reacting living anionic polymers based on the aforementioned monomers with functional organic compounds containing at least three groups capable of reacting with the living polymers and at least one group in the molecule serving for the modification of the polymers, have very good processing properties as well as improved physical and dynamic properties, together with the advantage that the coupling agents used do not exhibit any toxic effect during the processing.

The polymers according to the present invention are suitable for the production of all types of molded articles, in particular for the production of tires and tire structural parts, golf balls and technical rubber articles, as well as for the production of rubber-reinforced plastics such as ABS and HIPS plastics.

### FIELD OF THE INVENTION

The present invention relates to coupled diene polymers modified with electrophilic groups and uses thereof. The present invention also relates to the production of coupled diene polymers modified with electrophilic groups.

### BACKGROUND OF THE INVENTION

It is known, in particular for use in tire construction, to crosslink (couple) living, such as living alkali-terminated polymers based on conjugated dienes or based on conjugated dienes and vinylaromatic compounds with organic or inorganic compounds particularly suitable for this purpose, in which the processing properties as well as the physical and dynamic properties, especially those relating to the rolling resistance in tires, are improved.

Crosslinking agents that are used in the industry for the aforementioned rubbers include, apart from a very wide range of organic compounds with corresponding groups capable of crosslinking with the living polymers, such as epoxy groups, isocyanate groups, aldehyde groups, keto groups, ester groups as well as halide groups, and silicon or tin compounds such as their halides, sulfides or amines. Reference may be made to, DE 19 857 768 A 1, which describes known crosslinking or coupling agents and discusses new epoxy group-containing organic crosslinking agents as well as polymers crosslinked therewith. Furthermore, EP-A 0 890 580 and EP-A 0 930 318 describe diene polymers or copolymers that have been coupled by using tin halides and in addition have also been terminated or modified with hydroxysiloxanes, as described in EP-A 0 890 580. In DE 19 803 039 A 1 rubber compositions for high performance tire treads are described, in which the rubbers on which the compositions are based have been partially coupled with tin, phosphorus, gallium or silicon compounds.

Furthermore rubber mixtures are known from WO 01/123467A1, which describes mixtures that contain a rubber based on conjugated dienes that has been modified with polyfunctional compounds containing two or more epoxy groups. The diene rubber described therein is functionalized to more than 60 wt. % with the polyfunctional compounds in the terminal group. As can be seen inter alia from the tables of the patent application, a coupling reaction, has not in practice, taken place with the employed polyfunctional compounds.

In Japanese patent application 7 330 959-A2 rubber mixtures for tire treads are described that contain coupled and modified styrene-butadiene copolymer produced in solution. The styrene-butadiene copolymer described therein has a molecular weight ratio (M_{W}/Mn) of 2.2 to 3.2 and a weight average molecular weight (M_{W}) of ≧500,000.

Since the prior used crosslinking agents still have considerable disadvantages, such as the formation of undesirable subsidiary products during the coupling, toxicity of the crosslinking agents or insufficient crosslinking of the polymers with the coupling agents (DE 19 857 768 A1), crosslinking agents and coupling agents are sought that do not exhibit the disadvantages of the coupling agents and crosslinking agents used previously and that moreover also exhibit additional advantages in the processing behavior of the produced polymers and in the physical and dynamic properties of the vulcanizates.

In addition it should also be mentioned that the rubbers described in WO 01/123467 A1 and JP 7 330 959-A2 undergo practically no coupling and therefore exhibit only a slight degree of branching (WO 01/123467 A1), have a high molecular weight combined with a broad molecular weight distribution (JP 7 330 959-A2). Also, the modified and/or coupled rubbers described in the patent publications that have just been mentioned do not exhibit an optimal ratio between the processing properties of the rubbers and the physical and dynamic properties of the vulcanizates.

### SUMMARY OF THE INVENTION

The object of the present invention was accordingly to provide stellate (highly branched) crosslinked diene polymers and copolymers modified with electrophilic groups that exhibit good processing properties combined with improved physical and dynamic properties, and that are able to interact with fillers via the electrophilic groups present in the molecule.

A further object of the present invention was to couple diene polymers and copolymers with coupling agents and/or crosslinking agents that do not produce any toxic effect and therefore do not have to be processed using special protective measures.

Accordingly, the present invention provides coupled polymers modified with electrophilic groups, based on conjugated dienes or on conjugated dienes and vinylaromatic compounds as well as polyfunctional compounds with at least three groups capable of coupling and at least one electrophilic group serving for the modification, in which the polymers have a molecular weight ratio (M_{W}/Mn) of 1.0 to 2.1, a weight average molecular weight (M_{W}) of ≧50,000, a glass transition temperature (T_{g}) of −100° to −10° C., an amount of vinyl groups in the polymer of 5 to 90% referred to the diene units present in the polymer, and a crosslinking number (coupling number) of at least 2, and in which the proportion of electrophilic groups serving for the modification, referred to the amount of alkali metal-terminated polymer anions formed as intermediates in the production of the polymer, is 2 to 33 mole %.

### DETAILED DESCRIPTION OF THE INVENTION

Preferably the proportion of electrophilic groups serving for the modification, referred to the amount of alkali metal-terminated polymer anions formed as intermediates in the production of the polymer, is 5 to 25 mole %, preferably 10 to 25 mole %.

As previously mentioned, the modified polymers according to the present invention are produced by reacting living anionic polymers that are normally terminated by appropriate alkali metals with the functional organic compounds according to the present invention. The anionic polymerization of unsaturated compounds is a widely used process, for example for producing corresponding elastomers, and is of course well known to the person skilled in the art. Such anionic polymerization reactions plus relevant theoretical background are described in more detail in, inter alia, Polymer Synthesis (Paul Rempp and Erdward W. Merill) Huethig and Wepf-Verlag, Basel, Heidelberg, New York, 1986, pp. 114 to 138, as well as in Science and Technology of Rubber, second edition, (edited by: Shane E. Mark, Burak Erman and Frederick R. Eirich) Academic Press, 1994, pp. 60 to 70. Furthermore reference is made again to DE 198 57 768 A1, which describes the coupling of living alkali metal-terminated polymers with a crosslinking agent containing an epoxy group.

As conjugated dienes for the synthesis of the living anionic polymers there may be used all known dienes that are conventionally used for the production of the corresponding polymer anions. The following dienes may be mentioned by way of example: 1,3-butadiene, 2,3-dimethyl-1,3-butadiene, 3-butyl-1,3-octadiene, isoprene, piperylene, 1,3-hexadiene, 1,3-octadiene, 2-phenyl-1,3-butadiene, preferably 1,3-butadiene and isoprene, as well as mixtures thereof.

Suitable as vinylaromatic compounds are also the known vinylaromatic compounds that can be copolymerized together with the conjugated dienes. The following may be mentioned by way of example: styrene, p-methylstyrene, α-methylstyrene, 3,5-dimethylstyrene, vinylnaphthalene, p-tert.-butylstyrene, divinylstyrene, divinylethylene, 4-propylstyrene, p-tolylstyrene, 1-vinyl-5-hexylnaphthalene, 1-vinylnaphthalene, preferably styrene, or mixtures thereof.

In the copolymerization of the aforementioned conjugated dienes with the vinylaromatic compounds the amount of vinylaromatic compounds that are used is normally 5 to 55 wt. %, preferably 10 to 45 wt. %, and the amount of conjugated dienes that are used is normally 45 to 95 wt. %, preferably 55 to 90 wt. %. The copolymers may be a random, step-block or complete block copolymer of the various aforementioned monomers.

The living anionic polymers based on the aforementioned monomers are—as already mentioned—terminated by alkali metals and are used in this form for the reaction with the functional organic compounds according to the present invention.

Suitable as terminating alkali metal includes the alkali metals lithium, sodium, potassium, rubidium and cesium, preferably lithium.

As polyfunctional compounds, according to the present invention, organic compounds are used that contain, in the molecule, at least three groups capable of coupling and at least one electrophilic group serving for the modification. In this connection it is possible for the groups capable of coupling to be identical to the electrophilic groups serving for the modification.

The polyfunctional compounds used according to the present invention preferably contain 3 to 10, more preferably 3 to 4 groups that are capable of reacting with the living anionic polymers. Furthermore, the polyfunctional compounds also contain 1 to 5, preferably 1 to 3 groups that serve for the modification of the polymers.

Groups that are capable of engaging in the coupling reaction with the living anionic polymers include epoxy groups, isocyanate groups, aldehyde groups, keto groups, ester groups, acid halide groups, alkoxysilane groups, thiurane groups, sulfenyl chloride groups, as well as silicon halide and tin halide groups. Preferred are epoxy groups, aldehyde groups, keto groups, ester groups, silicon halide groups and tin halide groups. More preferred are epoxy groups.

These groups may also, as mentioned herein, serve for the modification of the polymers.

Furthermore suitable groups serving for the modification of the polymers include for example: tert. -amino groups, ether groups (symmetrical and asymmetrical), ammonium groups, siloxane groups and/or thioether groups. Preferred are amino groups, ether groups and/or siloxane groups, more preferred are amino groups and/or ether groups. These groups serve for the modification of the polymers and do not participate in any coupling reactions with the living polymers.

Accordingly, the functional organic compounds that are used, may as regards to their substituents, be built up symmetrically (i.e. all the groups or substituents in the molecule are identical) or asymmetrically (i.e. the groups have a different chemical structure).

The above definition of the functional organic compounds refers to the compounds as they exist before the coupling reaction. This means that after the coupling reaction additional groups capable of the modification of the polymers may be formed, for example epoxy or hydroxy groups.

As functional organic compounds of the aforementioned type, the following compounds for example may be used as coupling agents and modification agents: N,N-bis-(2,3-epoxypropoxy)-aniline, 4,4-methylene-bis-(N,N-glycidylaniline), tris-(2,3-epoxypropyl)-1,3,5-triazine-2,4,6-triones, trimethylolethane triglycidyl ether, trimethylolpropane triglycidyl ether or triglycidyl glycerol, in particular 4,4-methylene-bis-(N,N-glycidylaniline), triglycidyl glycerol or N,N-bis-(2,3-epoxypropoxy)-aniline, as well as their mixtures with one another.

The crosslinking ratio and the properties of the resultant crosslinked modified polymers depend, inter alia, on the amount of crosslinking agent that is used. For this reason it is convenient to determine the most favorable amount of crosslinking agent by suitable preliminary tests.

The coupled polymers modified with electrophilic groups, according to the present invention, preferably have a molecular weight ratio (M_{W}/Mn) of 1.2 to 2.0, more preferably 1.5 to 2.0. The weight average molecular weight (M_{W}) is preferably in the range from 50,000 to 1,000,000, more preferably 100,000 to 800,000. The amount of vinyl groups in the polymer is preferably in the range from 10 to 90 wt. %. The polymers according to the present invention preferably have a crosslinking number in the range from 2 to 4.

To produce the coupled and modified polymers, according to the present invention, the reaction of the living anionic polymers with the functional organic compounds, according to the present invention, is carried out in a conventional way in the presence of inert, aprotic solvents. Such inert aprotic solvents may be paraffin hydrocarbons such as isomeric pentanes, hexanes, heptanes, octanes, decanes, 2,4-trimethylpentane, cyclopentane, cyclohexane, methylcyclohexane, ethylcyclohexane or 1,4-dimethylcyclohexane, or aromatic hydrocarbons such as benzene, toluene, ethylbenzene, xylene, diethylbenzene or propylbenzene. These solvents may be used individually or in combination. Cyclohexane and n-hexane are preferred.

Optionally a polar solvent may be added to the aforementioned aprotic solvents in the copolymerization of vinylaromatic compounds with the conjugated dienes in order to increase the polymerization rate and/or to modify the polymer structures. Suitable polar solvents include ethers such as tetrahydrofuran, diethyl ether, cycloamyl ether, dipropyl ether, ethylenedimethyl ether, ethylenediethyl ether, diethylene glycol, dimethyl ether, tert.-butoxyethoxane or bis-(2-dimethylaminoethyl) ether, preferably tert.-butoxyethoxyethane or bis-(2-dimethylaminoethyl) ether, as well as tertiary amines such as trimethylamine, triethylamine, tripropylamine or tetramethylethylenediamine, preferably triethylamine or tetramethylethylenediamine. The microstructure of the corresponding copolymers may in addition, as previously mentioned, be altered by the addition of polar solvents, for example from a step-block structure to a random structure. The polar solvents used to modify the polymer structure are used in the anionic polymerization in general in amounts of 0.1 to 40 moles, preferably 0.1 to 10 moles, referred to 1 mole of the employed initiator.

The amount of solvents that are used may vary within wide limits. The amount is generally about 300 to 1500 parts by weight per 100 parts by weight of total monomers.

The production of the coupled and modified polymers, according to the present invention, takes place substantially in two stages. In the first step a living anionic, alkali metal-terminated polymer is produced, which is then crosslinked in the second step with the functional organic compounds according to the present invention defined hereinbefore. These organic compounds may be added at any suitable point in the polymerization depending on the desired properties of the polymers to be produced.

The first step in the production of the polymers, according to the present invention, is generally carried out by reacting an alkali metal initiator system with the respective monomer or monomers in order to form the living anionic polymers. This polymerization step may be carried out in one step or in a succession of steps. If the polymer chain is a homopolymer or a random or step copolymer containing two or more monomers, then the monomers are polymerized simultaneously with the alkali metal initiator. If the polymer chain is a block copolymer containing two or more homopolymers or copolymers, then the individual blocks can be produced with incremental or successive additions of monomer.

The alkali metal-based initiator systems used in the first step of the process for the production of the crosslinked polymers according to the present invention are based on alkali metal compounds of the general formula R¹-M wherein R¹ is a hydrocarbonyl radical with 1 to 20 carbon atoms and M is an alkali metal selected from lithium, sodium, potassium, rubidium or caesium. Examples of such lithium starters include methyllithium, isopropyllithium, n-butyllithium, s-butyllithium, isobutyllithium, tert.-butyllithium, tert.-octyllithium, hexyllithium, n-undecyllithium, phenyllithium, naphthyllithium, p-tolyllithium, 4-phenylbutyllithium, cyclohexyllithium and 4-cyclohexylbutyllithium. The amount of alkali metal compounds used is governed by the desired properties of the polymer, such as by the desired molecular weight. Normally the alkali metal compounds are used in an amount in the range from 0.2 to 20 mmoles per 100 g of total monomers.

The polymerization reaction is carried out in the presence of the aforementioned inert aprotic solvents, optionally mixed with polar solvents.

The polymerization temperature may vary within wide limits and is generally in the range from 0° C. to 200° C., preferably 40° C. to 130° C. The reaction time also varies within wide limits, ranging from a few minutes up to several hours. The polymerization is usually carried out within a time ranging from about 30 minutes up to 8 hours, preferably 4 hours. The polymerization may be carried out at normal pressure as well as at elevated pressure (1 to 10 bar).

In order to carry out the second reaction step (crosslinking step) the mixture obtained in the polymerization is mixed with the aforementioned functional organic compounds, which serve as coupling agents.

In the coupling reaction care should be taken to ensure that no interfering compounds that could adversely affect the coupling reaction are present. Such interfering compounds include for example carbon dioxide, oxygen, water, halides, alcohols and organic and inorganic acids.

The coupling reaction is normally carried out at temperatures that correspond roughly to the temperatures of the polymerization reaction. This means that the crosslinking reaction is carried out at temperatures from about 0° C. to 200° C., preferably 50° C. to 120° C. The crosslinking reaction may also be carried out at normal pressure as well as at elevated pressure (1 to 10 bar).

The reaction time of the coupling reaction is relatively short, and is in the range from about 1-minute to about 1 hour.

According to the present invention about 0.03 to 0.33 mole, preferably 0.1 to 0.26 mole of polyfunctional organic compounds are used per mole of alkali metal-terminated polymer anions for the coupling reaction.

After the crosslinking reaction, the coupled and modified polymers that have now been obtained are recovered by treating the reaction mixture with terminating agents that contain, as mentioned above, active hydrogen, such as alcohols or water or corresponding mixtures. Furthermore it is advantageous if antioxidants are added to the reaction mixture before the crosslinked polymer is isolated.

The separation of the polymer, according to the present invention, is carried out in a conventional manner by, for example, steam distillation or flocculation with a suitable flocculating agent such as alcohols. The flocculated polymer is then removed, for example, by centrifugation or extrusion from the resultant medium. Residual solvent and other volatile constituents can be removed from the isolated polymer by heating, optionally under reduced pressure or in an air stream from a fan.

The production of the polymers according to the present invention may be carried out batchwise, as well as, continuously. A continuous procedure in a reactor cascade consisting of several, preferably at least two, more preferably two to four, reactors connected in series is preferred.

The present invention, accordingly, also provides a process for the production of coupled polymers modified with electrophilic groups and based on conjugated dienes or on conjugated dienes and vinylaromatic compounds as well as on polyfunctional compounds with at least three groups capable of coupling and at least one electrophilic group serving for the modification and having the aforementioned physical parameters, which process is characterized in that conjugated dienes or conjugated dienes together with vinylaromatic compounds are polymerized in a conventional way in the presence of inert organic solvents and in the presence of organic alkali metal compounds, the alkali metal-terminated polymer anions that are formed are reacted with polyfunctional compounds containing at least three groups capable of coupling and with at least one electrophilic group serving for the modification, in which the molar ratio of polyfunctional compounds that are used to the alkali metal-terminated polymer anions is 0.03 to 0.33: 1.

Conventional compounding components such as fillers, dyes, pigments, softening agents and reinforcing agents may also be added to the polymers according to the present invention. Furthermore, known rubber auxiliary substances and crosslinking agents such as are described in “Handbuch für die Gummiindustrie”, 2^{nd} Edition, 1991, Editors: Bayer AG, may be used. Furthermore, it is also possible to mix the polymers according to the present invention with known rubbers in a known manner in order to achieve special property profiles for the rubber molded articles that are to be produced.

The coupled and modified polymers according to the present invention may be used in a known manner for the production of all forms of vulcanizates and/or rubber molded articles, such as for the production of tires and tire component parts, golf balls and other industrial rubber articles, as well as for the production of rubber-reinforced plastics such as ABS and HIPS plastics.

### EXAMPLES

### Example 1:

a) Production of an anionic lithium-terminated styrene-butadiene copolymer:

8500 g of technical grade hexane were placed in an autoclave flushed with nitrogen and equipped with a stirrer. 90 mmoles of tert.-butoxyethoxyethane, 0.80 mmole of potassium tert.-amylate and 12 mmoles of n-butyllithium (BuLi) were next added to the hexane while stirring. 1125 g of dried, destabilized 1,3-butadiene and 375 g of dried, destabilized styrene were then metered into this mixture. The polymerization of the monomers was carried out at a temperature of 70° C. up to a quantitative conversion of the monomer.

b) Coupling of the copolymer produced according to a) The following were added directly—in situ—to the polymer obtained in a)

1) 4 mmoles of N,N-bis-(2,3-epoxypropyl)-4-(2,3-epoxypropoxy)aniline (coupling agent 1) or

2) 3 mmoles of 4,4-methylene-bis-(N,N-diglycidylaniline) (coupling agent 2) or

3) 4 mmoles of triglycidyl glycerol (coupling agent 3) and the mixture was stirred at a temperature of ca. 70° C. for about 1 hour. The reactor contents were then cooled and the reaction was terminated with ethanol. The product obtained was then stabilized with Vulkanox® BHT and dried at 60° C. in a drying cabinet.

Molar ratio of coupling agent to Li-terminated polymer:

1) 0.33 mole (coupling agent 1): 1 mole (polymer)

2) 0.253 mole (coupling agent 2): 1 mole (polymer)

3) 0.33 mole (coupling agent 3): 1 mole (polymer)

The specified molar ratios refer to complete coupling.

Comparison Example:

The production of the non-coupled and unmodified styrene-butadiene copolymer is carried out as described in Example 1a). The subsequent coupling of the copolymer produced is carried out directly—in situ—with 6 mmoles of N,N-diglycidylaniline (coupling agent 4). The reaction times of the coupling as well as the working-up of the polymers was carried out as described in 1b).

Molar ratio of coupling agent to Li-terminated polymer:

5) 0.5 mole (coupling agent 4): 1 mole (polymer)

The specified molar ratio also refers to the complete coupling with the polymer.

The SBR copolymer coupled with the coupling agent 4 is denoted as “Reference” in the following tables.

TABLE 1
the analysis of the modified polymers obtained gave the following data:

| | | | | | | | | GPC | |
|---|---|---|---|---|---|---|---|---|---|
| | | Styrene | 1,4-cis | 1,4-trans | Vinyl | L Value | Tg | | Polydispersion |
| | ML1 + 4 @ 100° C. | [%] | [%] | [%] | [%] | [mg/l] | [° C.] | M_{W} | M_{W}/Mn |
| Example 1 before coupling | 61 | — | — | — | — | 219 | — | 293328 | 1.3 |
| Example 1 after coupling | | | | | | | | | |
| With coupling agent 1 | 78 | 22.5 | 11.5 | 14.6 | 51.4 | 267 | −21 | 397060 | 1.6 |
| With coupling agent 2 | 76 | 22.9 | 13.0 | 17.7 | 46.6 | 313 | −22 | 495935 | 2.1 |
| With coupling agent 3 | 69 | 21.1 | 13.4 | 17.5 | 48.0 | 330 | −25 | 454043 | 1.7 |
| Comp. Example before | 60 | — | — | — | — | 209 | — | 282776 | 1.4 |
| coupling | | | | | | | | | |
| Comp. Example after coupling | 75 | 22.1 | 11.3 | 14.0 | 52.6 | 245 | −20 | 353577 | 1.5 |
| with coupling agent 4 | | | | | | | | | |
| (Reference) | | | | | | | | | |

ML 1 + 4 Mooney values
GPC: Gel permeation chromatography
M_{W}: Mean molecular weight
L Value: Viscosity of the solution—0.5 g polymer/100 ml toluene

TABLE 2
rubber mixtures with variously coupled polymers
Carbon black mixtures

| | Example | Example | Example | |
|---|---|---|---|---|
| | 2 | 1 | 3 | Reference |
| Polymer with coupling | 60 | | | |
| agent 2 | | | | |
| Polymer with coupling | | 60 | | |
| agent 1 | | | | |
| Polymer with coupling | | | 60 | |
| agent 3 | | | | |
| Reference | | | | 60 |
| Buna CB 25 | 40 | 40 | 40 | 40 |
| Carbon black N 234 | 50 | 50 | 50 | 50 |
| Mineral oil* | 5 | 5 | 5 | 5 |
| ZnO RS | 3 | 3 | 3 | 3 |
| Stearic acid | 2 | 2 | 2 | 2 |
| Antilux 654** | 1.5 | 1.5 | 1.5 | 1.5 |
| Vulkanox HS**** | 1 | 1 | 1 | 1 |
| Vulkanox 4020*** | 1 | 1 | 1 | 1 |
| Vulkacit CZ****** | 1.4 | 1.4 | 1.4 | 1.4 |
| Vulkacit D******* | 0.3 | 0.3 | 0.3 | 0.3 |
| Sulfur | 1.8 | 1.8 | 1.8 | 1.8 |
| Mixture properties, | | | | |
| DIN 53523 | | | | |
| Mooney viscosity ML | 74 | 81 | 87 | 78 |
| 1 + 4 @ 100° C. | | | | |

TABLE 3
vulcanizate properties, ISO 37

| | | | | |
|---|---|---|---|---|
| Strength, MPa | 19 | 21.5 | 20 | 19.3 |
| Elongation at break, % | 420 | 435 | 400 | 405 |
| Tensile modulus 100%, Mpa | 2.8 | 2.6 | 2.6 | 2.6 |
| Tensile modulus 300%, Mpa | 14.7 | 13.1 | 13.6 | 12.5 |
| Degree of reinforcement | 5.3 | 5.0 | 5.2 | 4.8 |
| Hardness 23° C., Shore A | 67 | 67 | 66 | 67 |
| Hardness 70° C., Shore A | 64 | 63 | 65 | 63 |
| Elasticity 23° C., % | 44 | 42 | 48 | 42 |
| Elasticity 70° C., % | 60 | 58 | 59 | 57 |
| Roelig, 10 HZ, DIN 53513 | | | | |
| tan delta 60° C. | 0.133 | 0.133 | 0.124 | 0.137 |

The polymers according to the invention with coupling agents 1, 2 and 3 exhibit significant advantages as regards the degree of reinforcement compared to the reference polymer (Reference) in typical carbon black-filled vulcanizates for tire treads, which clearly illustrates the interaction of the polymer with the filler. As a consequence this leads to an increase in the elasticity, especially at high temperatures (70° C.), and to a lowering of the tan delta value according to Roelig at 60° C., which is equated by the person skilled in the art to a reduction of the rolling resistance of correspondingly produced tires.

TABLE 4
silicic acid mixtures

| | Example | Example | Example | |
|---|---|---|---|---|
| | 2 | 1 | 3 | Reference |
| Polymer with coupling | 70 | | | |
| agent 2 | | | | |
| Polymer with coupling | | 70 | | |
| agent 1 | | | | |
| Polymer with coupling | | | 70 | |
| agent 3 | | | | |
| Reference | | | | 70 |
| Buna CB 25 | 30 | 30 | 30 | 30 |
| Mineral oil* | 37.5 | 37.5 | 37.5 | 37.5 |
| Vulkasil S******** | 80 | 80 | 80 | 80 |
| Silane Si 69********* | 6.4 | 6.4 | 6.4 | 6.4 |
| ZnO RS | 2.5 | 2.5 | 2.5 | 2.5 |
| Stearic acid | 1 | 1 | 1 | 1 |
| Vulkanox HS**** | 1 | 1 | 1 | 1 |
| Vulkanox 4020*** | 1 | 1 | 1 | 1 |
| Vulkacit CZ****** | 1.8 | 1.8 | 1.8 | 1.8 |
| Vulkacit D******* | 2 | 2 | 2 | 2 |
| Sulfur | 1.5 | 1.5 | 1.5 | 1.5 |
| Mixture properties, | | | | |
| DIN 53523 | | | | |
| Mooney viscosity | 73.5 | 83.8 | 90 | 79.4 |
| ML1 + 4 @ 100° C. | | | | |
| Vulcanizate properties, | | | | |
| ISO 37 | | | | |
| Strength, MPa | 18.5 | 17.5 | 18.1 | 17.4 |
| Elongation at break, % | 436 | 430 | 430 | 435 |
| Tensile modulus 100%, | 3.0 | 2.8 | 2.9 | 3.1 |
| MPa | | | | |
| Tensile modulus 300%, | 11.3 | 10.6 | 10.8 | 10.4 |
| MPa | | | | |
| Degree of reinforcement | 3.8 | 3.8 | 3.7 | 3.4 |
| Hardness 23° C., | 75 | 75 | 75 | 76 |
| Shore A | | | | |
| Hardness 70° C., | 70 | 71 | 72 | 70 |
| Shore A | | | | |
| Elasticity 23° C., % | 34 | 32 | 39 | 32 |
| Elasticity 70° C., % | 54 | 54 | 56 | 54 |
| Roelig, 10 HZ, | | | | |
| DIN 53513 | | | | |
| tan delta −20° C. | 0.457 | 0.415 | 0.462 | 0.382 |
| 60° C. | 0.127 | 0.127 | 0.112 | 0.129 |

*Enerthene 1849-1, mineral oil plasticiser, Mobil Schmierstoff GmbH
**Light protection wax, Rhein Chemie Rheinau
***Anti-ageing agent (6PPD), Bayer AG
****Anti-ageing agent (TMQ), Bayer AG
*****Sulfenamide accelerator (CBS), Bayer AG
******Guanidine accelerator (DPG), Bayer AG
*******Silicic acid, Bayer AG
********Silane, Degussa

In vulcanizates filled with silicic acid the polymers according to the present invention also exhibit an improved interaction with the filler, expressed by increased degrees of reinforcement. In addition to the reduced rolling resistance (lower tan delta at 60° C.), with this type of tire tread mixtures the wet properties of tires produced therefrom are improved (increased tan delta at −20° C.).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A modified coupled polymer comprising electrophilic groups based on conjugated dienes or both conjugated dienes and vinylaromatic compounds as well as polyfunctional compounds with at least three groups capable of coupling and at least one electrophilic group which modifies the couple polymer, in which the polymer has a molecular weight ratio (M_{W}/Mn) of 1.0:2.1, a weight average molecular weight (M_{W}) of ≧50,000, a glass transition temperature (T_{g}) of −100° to −10° C., an amount of vinyl groups in the coupled polymer ranging from 5 to 90% referred to the diene units present in the coupled polymer, and a crosslinking number (coupling number) of at least 2, and in which the proportion of electrophilic groups which modifies the coupled polymer, referred to the amount of the alkali metal-terminated polymer anions formed as intermediates in the production of the coupled polymer, is 3 to 33 mole %.

2. The modified coupled polymer according to claim 1, wherein the vinylaromatic compound is styrene, p-methylstyrene, α-methylstyrene, 3,5-dimethylstyrene, vinylnaphthalene, p-tert.-butylstyrene, divinylstyrene, divinylethylene, 4-propylstyrene, p-tolylstyrene, 1-vinyl-5-hexylnaphthalene and/or 1-vinyinaphthalene.

3. The modified coupled polymer according to claim 1, wherein the conjugated diene is 1,3-butadiene and/or isoprene, the vinylaromatic compound styrene.

4. The modified coupled polymer according to claim 1, wherein the conjugated diene is present in amount of 45 to 95 wt. % and the vinylaromatic compound is present in amounts of 5 to 55 wt. %.

5. The modified coupled polymer according to claim 1, wherein the functional organic compound is N,N-bis-(2,3-epoxypropoxy)-aniline, 4,4-methylene-bis-(N,N-glycidylaniline), tris-(2,3-epoxypropyl)-1,3,5-triazine-2,4,6-triones, trimethylolethane triglycidyl ether, trimethylolpropane triglycidyl ether or triglycidyl glycerol.

6. Process for the production of modified coupled polymer comprising electrophilic groups comprising the steps of polymerizing a conjugated diene or both a conjugated diene and an vinylaromatic compound in the presence of an inert organic solvent and in the presence of an organic alkali metal compound, reacting the alkali metal-terminated polymer anion that is formed during the polymerization step with a polyfunctional compound containing at least three groups capable of coupling and at least one electrophilic group which modifies the coupled polymer, wherein the molar ratio of polyfunctional compounds used to alkali metal-terminated polymer anions is 0.03 to 0.33:1.

7. A vulcanizate comprising a modified coupled polymer comprising electrophilic groups based on conjugated dienes or both conjugated dienes and vinylaromatic compounds as well as polyfunctional compounds with at least three groups capable of coupling and at least one electrophilic group which modifies the couple polymer, in which the polymer has a molecular weight ratio (M_{W}/Mn) of 1.0:2.1, a weight average molecular weight (M_{W}) of ≧50,000, a glass transition temperature (T_{g}) of −100° to −10° C., an amount of vinyl groups in the coupled polymer ranging from 5 to 90% referred to the diene units present in the coupled polymer, and a crosslinking number (coupling number) of at least 2, and in which the proportion of electrophilic groups which modifies the coupled polymer, referred to the amount of the alkali metal-terminated polymer anions formed as intermediates in the production of the coupled polymer, is 3 to 33 mole %.

8. A rubber molded article comprising a modified coupled polymer comprising electrophilic groups based on conjugated dienes or both conjugated dienes and vinylaromatic compounds as well as polyfunctional compounds with at least three groups capable of coupling and at least one electrophilic group which modifies the couple polymer, in which the polymer has a molecular weight ratio (M_{W}/Mn) of 1.0: 2.1, a weight average molecular weight (M_{W}) of ≧50,000, a glass transition temperature (T_{g}) of −100° to −10° C., an amount of vinyl groups in the coupled polymer ranging from 5 to 90% referred to the diene units present in the coupled polymer, and a crosslinking number (coupling number) of at least 2, and in which the proportion of electrophilic groups which modifies the coupled polymer, referred to the amount of the alkali metal-terminated polymer anions formed as intermediates in the production of the coupled polymer, is 3 to 33 mole %.

9. The rubber molded article according to claim 8, wherein the rubber molded article is a tire, a tire structural part, a golf ball, a rubber-reinforced plastic.
